(19) United States
(12) Patent Application Publication
(10) Pub. No.: US 2014/0012622 A1
(43) Pub. Date: Jan. 9, 2014

(54) DATA PROCESSING APPARATUS AND COMPUTER-READABLE STORAGE MEDIUM

(71) Applicant: Mitsuharu Kamiya, Tokyo (JP)

(72) Inventor: Mitsuharu Kamiya, Tokyo (JP)

(73) Assignee: CASIO COMPUTER CO., LTD., Tokyo (JP)

(21) Appl. No.: 13/922,422

(22) Filed: Jun. 20, 2013

(30) Foreign Application Priority Data
Jul. 4, 2012 (JP) 2012-150340

(51) Int. Cl. G06Q 30/02; G06Q 30/04

(52) U.S. Cl. CPC G06Q 30/0201; G06Q 30/04
USPC 705/7.29

(57) ABSTRACT

A data processing apparatus of the present invention, which receives sales data transmitted from a terminal device installed in a mobile sales vehicle via a communication network and processes the sales data, includes a receiving section which receives current position data and sales data from the terminal device as a sales report of mobile sales, a sales venue storage section which stores and manages position data for each of sales venues where mobile sales by mobile sales vehicles are permitted under contracts with operators operating business of renting the sales venues by hour, a search section which specifies a sales venue relevant to the position data by searching the sales venue storage section based on the position data received together with the sales data, and a processing section which processes, when the sales venue is specified, the sales data as sales data regarding sales at the sales venue.

### CROSS-REFERENCE TO RELATED APPLICATION

This application is based upon and claims the benefit of priority from the prior Japanese Patent Application No. 2012-150340, filed Jul. 4, 2012, the entire contents of which are incorporated herein by reference.

### BACKGROUND OF THE INVENTION

1. Field of the Invention

The present invention relates to a data processing apparatus which receives sales data transmitted from a terminal device via a communication network and processes the sales data, and a computer readable storage medium.

2. Description of the Related Art

In recent years, mobile sales where products are sold by using vehicles attract attention mainly from youths, women, and senior citizens. One reason for this is that operating hours and an operation venue can be freely determined. For operation of mobile sales, operating permission by the public health center based on the food sanitation law and road use permission by the police office based on the road traffic law are required. Unauthorized sales on the road is subjected to administrative disposition or criminal penalty.

Although parks are not road and therefore are not under control of the road traffic law, parks are under control of the city park law. To open a shop there, permission by a municipality is required and, in principal, the use for commercial purposes is not allowed.

Moreover, with regard to commercial advertising of mobile sales with the use of a loudspeaker, the sound volume and use are controlled under regulations by administrative divisions.

Conventionally, as a technology regarding mobile sales vehicles, a technology has been proposed in which the sales venue and travelling course of a mobile sales vehicle, sales products, and prices are searchable and viewable from portable phones and personal computers, a mail guide is sent, and advance reservations can be made (for example, refer to Japanese Patent Application Laid-Open (Kokai) Publication No. 2011-221984).

As such, conventional services for users using mobile sales are mostly systems allowing a search for sales venues and production information, and mail guide notifications.

Meanwhile, although no law regulates mobile sales on private lands such as parking lots, shopping malls, and vacant lots, permission from their landowner or manager is required. As mobile sales have become socially acknowledged, legal sales methods on private lands are indispensable to establish credibility. Under these circumstances, although sites for matching mobile sales vehicle with event organizers at commercial facilities are present in some network services, it is very difficult for mobile sellers to constantly secure an operation venue due to problems of operating days and competition in estimates.

Moreover, in a case where a commercial facility or a parking lot is rented to a mobile seller, credibility and contract procedures are required, and the term of contract is long. Therefore, it is difficult for mobile sellers, who are mostly private enterprises and microenterprises, to rent such a venue.

### SUMMARY OF THE INVENTION

An object of the present invention is to allow a mobile sales vehicle to be easily provided with a sales venue and to allow confirmation as to whether mobile sales are being conducted at an appropriate venue.

In accordance with one aspect of the present invention, there is provided a data processing apparatus which receives sales data transmitted from a terminal device installed in a mobile sales vehicle via a communication network and processes the sales data, comprising: a receiving section which receives current position data together with sales data from the terminal device, as a sales report of mobile sales; a sales venue storage section which stores and manages position data for each of sales venues where mobile sales by mobile sales vehicles are permitted under contracts with operators operating business of renting the sales venues by hour; a search section which specifies a sales venue relevant to the position data by searching the sales venue storage section based on the position data received together with the sales data by the receiving section; and a processing section which processes, when the sales venue is specified by the search section, the sales data received by the receiving section as sales data regarding sales at the sales venue.

In accordance with another aspect of the present invention, there is provided a non-transitory computer-readable storage medium having stored thereon a program that is executable by a computer, the program being executable by the computer to perform functions comprising: processing for receiving current position data together with sales data from a terminal device installed in a mobile sales vehicle, as a sales report of mobile sales; processing for storing and managing position data for each of sales venues where mobile sales by mobile sales vehicles are permitted under contracts with operators operating business of renting the sales venues by hour; processing for specifying a relevant sales venue based on the position data received together with the sales data from the terminal device; and processing for, when the sales venue is specified, causing the received sales data to be processed as sales data regarding sales at the sales venue.

According to the present invention, it is possible to easily provide a mobile sales vehicle with a sales venue and easily confirm as to whether mobile sales are being conducted at an appropriate venue, by which mobile sales are promoted and sales venues are effectively used.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram outlining the entire structure of a sales data processing system;

FIG. 2 is a block diagram depicting basic components of a management server device 1;

FIG. 3 is a block diagram depicting basic components of a sales terminal device 2;

FIG. 4 is a diagram for describing parking lot information database SD1 in the management server device 1;

FIG. 5 is a diagram for describing selling management information database SD2 in the management server device 1;

FIG. 6 is a diagram for describing sales management information database SD3 in the management server device 1;

FIG. 7A and FIG. 7B are diagrams for describing operation guide information database SD4 in the management server device 1;

FIG. 8 is a flowchart outlining the operation of a characteristic portion of the present embodiment from among all of the operations of the sales terminal device 2 installed in a mobile sales vehicle;

FIG. 9 is a flowchart outlining the operation of a characteristic portion of the present embodiment from among all of the operations of the management server device 1;

FIG. 10 is a flowchart of an operation following the operation of FIG. 9;

FIG. 11 is a flowchart of an operation following the operation of FIG. 10;

FIG. 12 is a flowchart outlining the operation of another characteristic portion of the present embodiment from among all of the operations of the management server device 1;

FIG. 13A is a diagram depicting a parking lot data guide screen and FIG. 13B is a diagram depicting a deputy collection business screen;

FIG. 14 is a diagram depicting a bill issued to a mobile seller; and

FIG. 15 is a diagram depicting a payment guide issued to a parking lot operator.

### DETAILED DESCRIPTION OF THE PREFERRED EMBODIMENTS

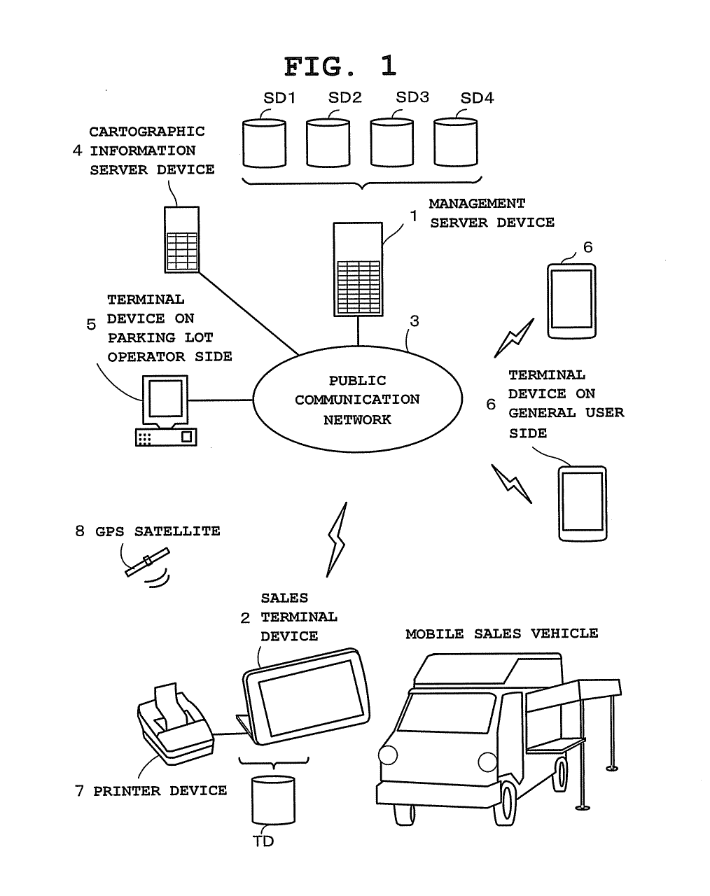

With reference to FIG. 1 to FIG. 15, an embodiment of the present invention is described below.

FIG. 1 is a block diagram outlining the entire structure of a sales data processing system.

The sales data processing system is a wide-area communication system which provides services usable by the hour by mobile sellers (mobile sales vehicles) anytime as required, for the purpose of effectively using pay-by-the-hour parking lots (sales venues) already operated in urban areas nationwide.

That is, the sales data processing system is a wide-area communication system which sets up a wide-area network service (a site for mobile sales using parking lots) for providing mobile sellers with parking areas (sales venues) where mobile sales are permitted under contracts with parking lot operators operating business of renting parking lots by the hour, as well as collecting use fees billed with the use of the parking areas (sales venues) from the mobile sellers and paying the fees to the parking lot operators.

The sales data processing system includes a management server device 1 which manages the entire system and a sales terminal device 2 installed on the mobile sales vehicle side. The management server device 1 and the sales terminal device 2 are connected to each other via a public communication network (for example, a wireless communication network or the Internet) 3.

The management server device 1 is a server device installed on the side of a site manager who manages a mobile sales site using parking lots, and is connected to the sales terminal device 2 on the mobile sales vehicle side via the public communication network 3 and to a cartographic information server device 4.

The management server device 1 is connected to a terminal device (such as a portable terminal device or a personal computer) 5 on a parking lot operator side via the public communication network 3 and to a terminal device (such as a portable terminal device or a personal computer) 6 on a general user side.

As various databases, a parking lot information database SD1, a selling management information database SD2, sales management information database SD3, and an operation guide information database SD4, and the like are provided to the management server device 1.

The parking lot information database SD1, the selling management information database SD2, the sales management information database SD3, and the operation guide information database SD4 will be described further below. The parking lot information database SD1 is a database for storing and managing position data for each parking area (each parking lot) where mobile sales by mobile sales vehicles are permitted under contracts with parking lot operators operating business of renting the parking lots by the hour.

For example, the sales terminal device 2 is a portable information terminal device whose housing is of A5 size as a whole, which is installed (mounted) inside a mobile sales vehicle. This sales terminal device 2 is a sales data processing device having a touch input function and a wireless communication function, as well as an ECR (Electronic Cash Register) function for registering sales data for each transaction and performing cutoff processing at the time of registration of one transaction.

Also, the sales terminal device 2 has, in addition to the basic functions described above (the touch input function, the wireless communication functions, and the ECR function), an Internet connecting function (a Web access function) and a GPS (Global Positioning System) function.

The sales terminal device 2 includes a sales management information database TD. The sales management information database TD has a sales file (omitted in the drawings) for storing inputted sales data (a product name, a unit cost, the number of items, and sales amount) and position data or the like received and obtained from the GPS function every time sales data for one transaction is registered in association with each other.

The sales terminal device 2 further has a printer device 7 connected thereto by a cable for printing and issuing a receipt or a journal. The GPS function is a function for receiving and obtaining current position data via a communication with a GPS satellite 8.

In the above-structured sales data processing system, when receiving current position data and the like together with sales data via the public communication network 3 as a sales report of mobile sales from the sales terminal device 2 installed on the mobile sales vehicle side, the management server device 1 searches the parking lot information database SD1 based on the position data so as to specify a parking area relevant to the position data, and processes the received sales data as sales data of sales in the parking area.

In this case, a parking fee according to the time of using the parking area and a compensation for sales according to the sales data are calculated to find a mobile sales use fee, and the mobile sales use fee is transmitted to a terminal device 5 on a parking lot operator side, whereby a payment report is made.

In the present embodiment, a plurality of adjacent parking spaces are provided to each mobile sales vehicle in a parking lot (a sales venue), as a venue for mobile sales. In this case, basically, spaces for two vehicles in total, or in other words, a space for one vehicle where the mobile sales vehicle is to be parked and an adjacent space for one vehicle where its sales are conducted are taken as a unit and provided to be rented by the hour for mobile sales.

Here, in the present embodiment, a parking fee for a parking space for one vehicle serves as a venue fee, on the assumption that the parking fee is collected by an existing parking system.

In this case, an amount obtained by adding the parking fee serving as a venue fee and a compensation for sales that is charged by quantity according to a sales amount (for example, a compensation accounting for 10% of the sales amount) together is taken as a mobile sales use fee, which is collected from the mobile seller and paid to the parking lot operator side.

Note that the site manager managing the mobile sales site using parking lots collects membership fees by the month or year from the mobile sellers and parking lot operators, or collects a commission from part of the mobile sales use fees described above (for example, 5%), and allocates the collected amounts to an operation cost.

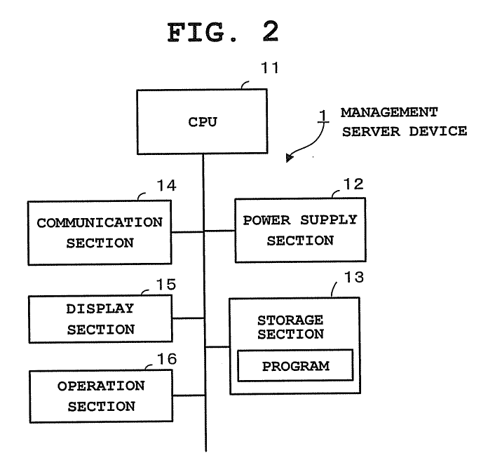

FIG. 2 is a block diagram depicting basic components of the management server device 1.

A CPU (Central Processing Unit) 11 in FIG. 2, which serves as the core of the management server device 1, operates by receiving power from a power supply section 12 including an Uninterruptible Power Supply device (UPS) (omitted in the drawings), and controls the entire operation of the management server device 1 in accordance with various programs in a storage section 13.

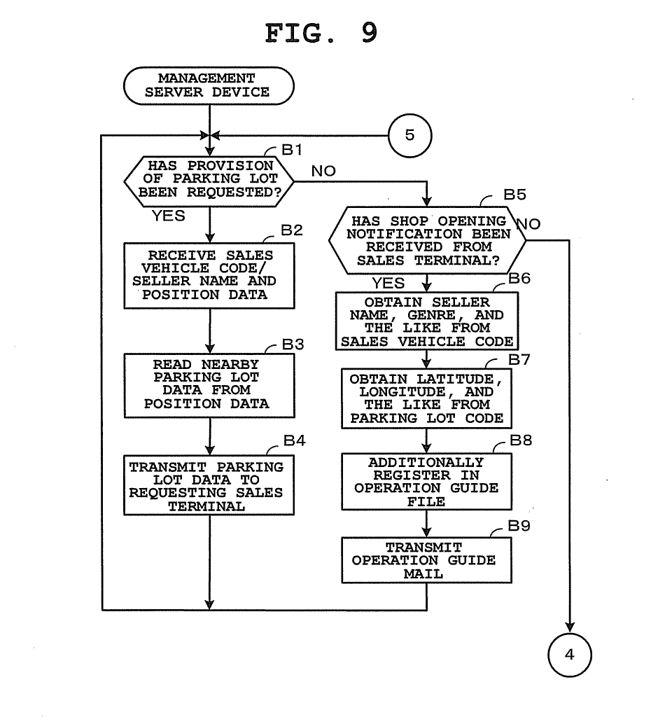

The storage section 13 stores various programs and information, such as programs and various applications for actualizing the present embodiment based on operation procedures depicted in FIG. 9 to FIG. 12, and has a work area for temporarily storing various information (such as a current time clocked by a clock function, a flag, and a timer) required to operate the management server device 1.

Note that the storage section 13 may include a storage area on a predetermined external server side.

A communication section 14 is capable of performing multiple simultaneous access. This communication section 14 is connected to broadband Internet (such as by optical communication connection), and transmits and receives data to and from the sales terminal device 2, the cartographic information server device 4, the terminal device 5 on the parking lot operator side, and the terminal device 6 on the general user side.

The CPU 11 can also perform processing in accordance with an external instruction received via the communication section 14. A display section 15 displays an operator confirmation screen, a work screen, etc. An operation section 16 includes a full keyboard and the like, and the CPU 11 performs processing based on input signals from this operation section 16.

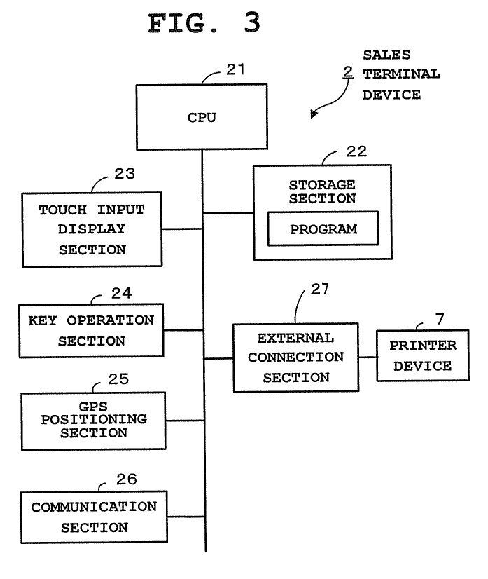

FIG. 3 is a block diagram depicting basic components of the sales terminal device 2.

A CPU 21 in FIG. 3, which serves as the core of the sales terminal device 2, controls the entire operation of the sales terminal device 2 in accordance with various programs in a storage section 22.

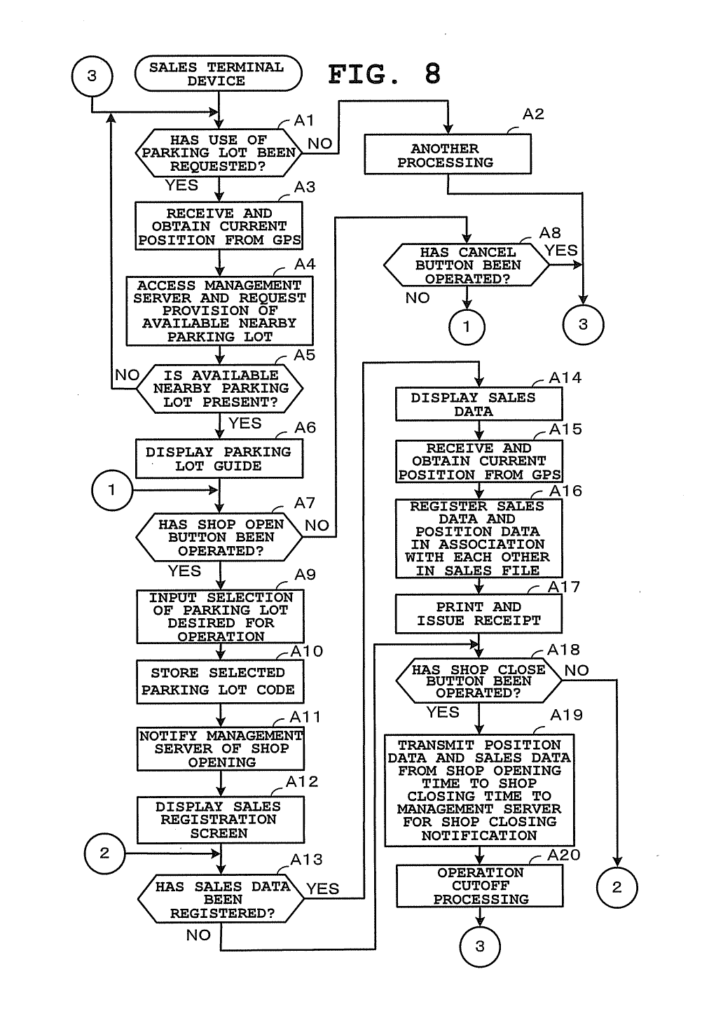

The storage section 22 stores various programs and information, such as programs and various applications for actualizing the present embodiment based on operation procedures depicted in FIG. 8, and has a work area for temporarily storing various information (such as a current time clocked by a clock function, a flag, and a timer) required to operate the sales terminal device 2.

To the CPU 21, a touch input display section 23 and a key operation section 24 are connected as input/output peripheral devices. Also connected are a GPS positioning section 25, a communication section 26, an external connection section 27, and others. The CPU 21 controls operations of these sections in accordance with an input/output program.

The touch input display section 23 is structured to include a display panel and a touch panel (omitted in the drawings). By the touch panel being arranged on the front surface of a high definition display panel, software keys (touch keys) are allocated and arranged. This touch input display section 23 displays function names, or senses a touch operation performed by a finger or the like and inputs data based on the touch operation.

The GPS positioning section 25 constitutes the GPS function described above, and receives and obtains current position data (longitude and latitude data) by using a control station of a ground system/satellite system.

The communication section 26 is a communication interface for transmitting and receiving data to and from the management server device 1 via the public communication network 3. The external connection section 27 is a connector section to which the printer device 7 is connected by a cable.

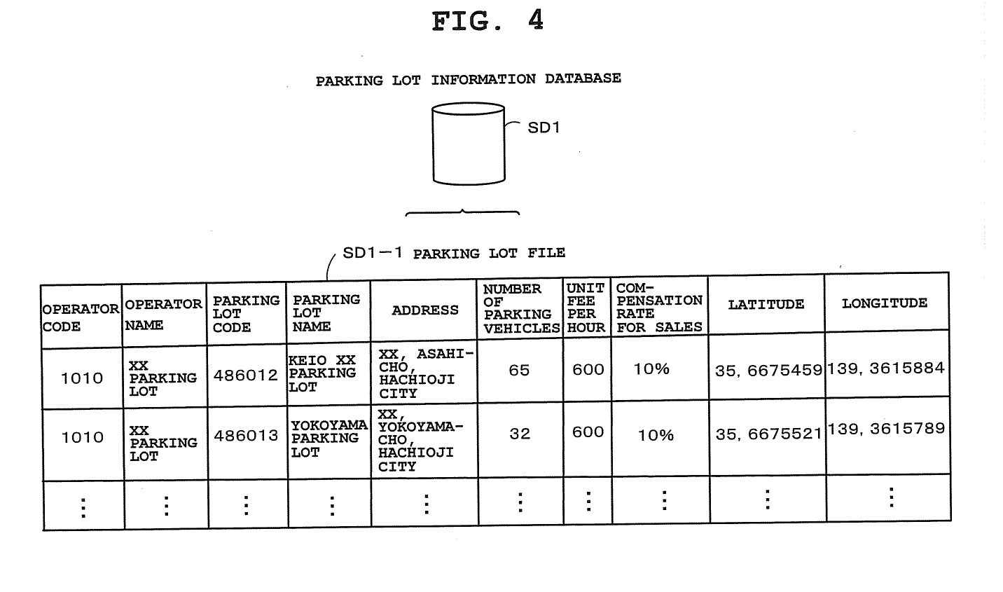

FIG. 4 is a diagram for describing the parking lot information database SD1 in the management server device 1.

The parking lot information database SD1 stores and manages data regarding parking lot operators, and has a parking lot file SD1-1.

The parking lot file SD1-1 is a file storing registered data by receiving inputs of items described in registration applications submitted from the parking lot operators, and has items of “operator code” and “operator name” as data regarding the parking lot operators and items of “parking lot code”, “parking lot name”, “address”, “the number of parking vehicles”, “unit fee per hour”, “compensation rate for sales”, “latitude”, and “longitude” as data regarding the parking lots (parking areas) operated by the operators.

“Unit fee per hour” indicates a pay-by-the-hour fee in the parking area (for example, two hundred yen for thirty minutes). “Compensation rate for sales” indicates a compensation rate to be billed by quantity according to a sales amount of movable sales (for example, 10% of the sales amount). “Latitude” and “longitude” are position data corresponding to “address” of the parking lot which have been received and obtained from the cartographic information server device 4.

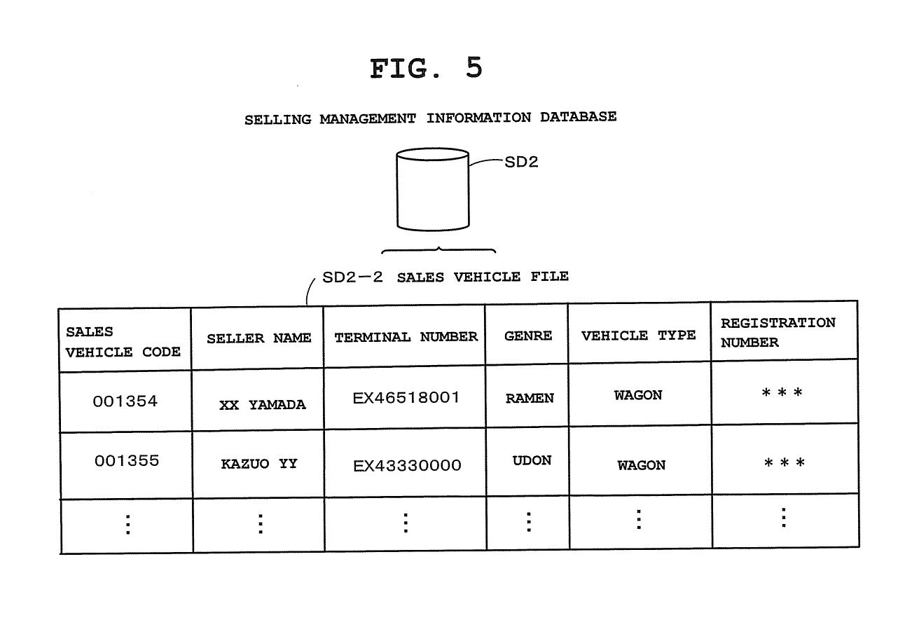

FIG. 5 is a diagram for describing the selling management information database SD2 in the management server device 1.

The selling management information database SD2 stores and manages data regarding mobile sellers (mobile sales vehicles), and has a sales vehicle file SD2-1.

The sales vehicle file SD2-1 is a file storing registered data by receiving inputs of items described in registration applications submitted from the mobile sellers, and has items of “sales vehicle code”, “seller name”, “terminal number”, “genre”, “vehicle type”, and “registration number” as data regarding the mobile sellers (mobile sales vehicles).

“Terminal number” is identification data (for example, a product serial number) of the sales terminal device 2 installed on each mobile sales vehicle. “Genre” indicates the type of a product for sale (for example, ramen, udon, etc.). “Vehicle type” and “registration number” are identification data identifying each mobile sales vehicle.

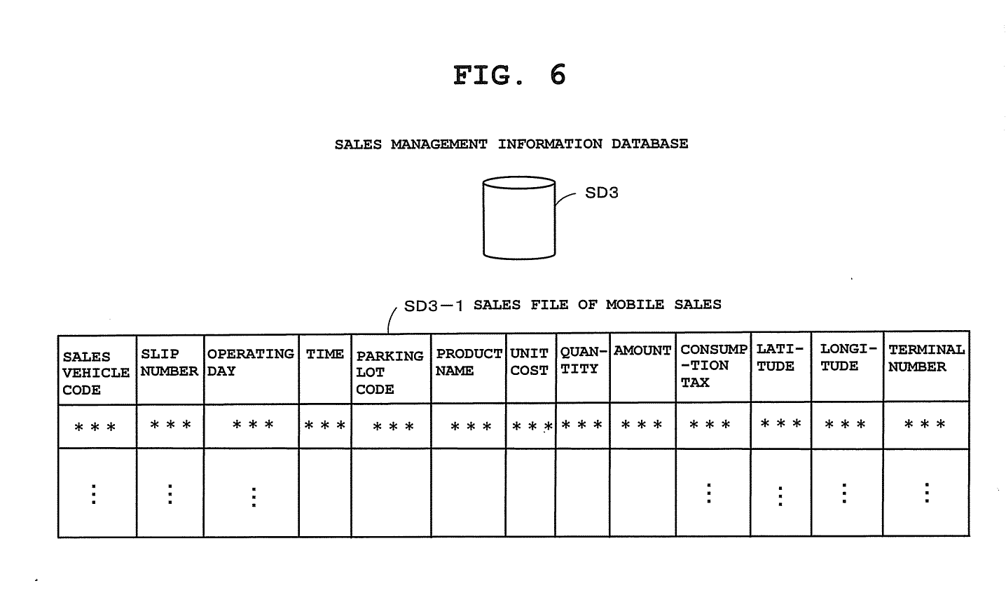

FIG. 6 is a diagram for describing the sales management information database SD3 in the management server device 1.

The sales management information database SD3 stores and manages sales data for each mobile sales vehicle, and has a sales file SD3-1 of mobile sales.

The sales file SD3-1 is a file storing data according to the contents of a sales report of mobile sales received from the sales terminal device 2, and has items of “sales vehicle code”, “slip number”, “operating day”, “time” “parking lot code”, “product name”, “unit cost”, “quantity”, “amount”, and “consumption tax” as sales data for each mobile sales vehicle and items of “latitude” and “longitude” as data regarding the parking areas used for mobile sales.

“Slip number” is a serial number issued for each transaction. “Operating day” and “time” indicate operating day and time of sales. “Amount” is a sales amount for one transaction, obtained by “unit cost”×“quantity”. “Latitude” and “longitude” are position data received and obtained by the GPS function in each parking area for mobile sales (position data indicating a venue where mobile sales are being conducted).

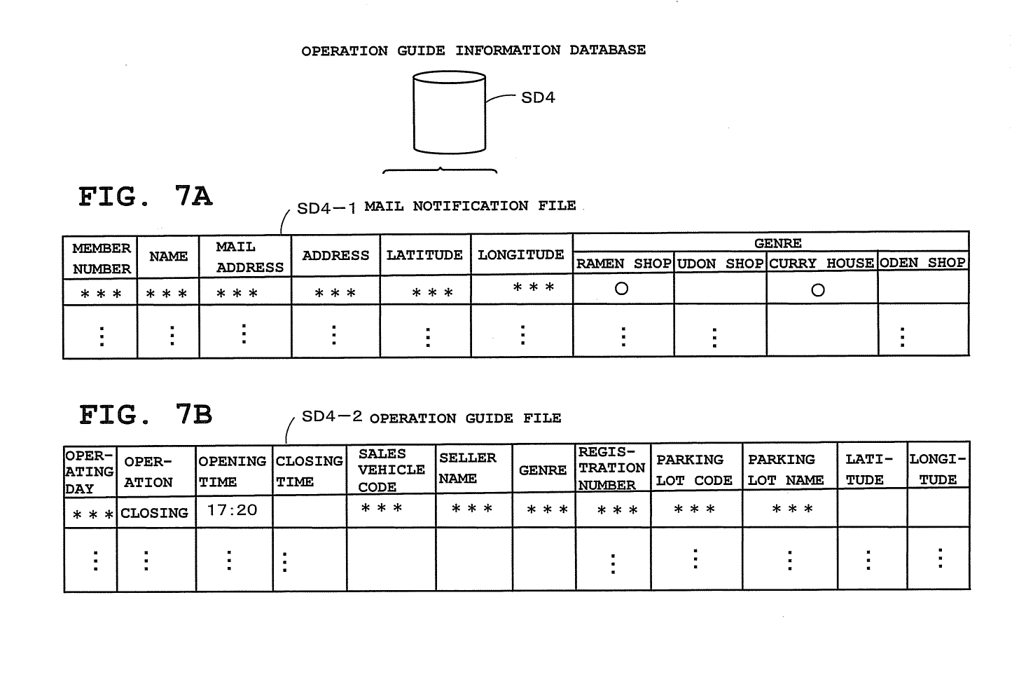

FIG. 7A and FIG. 7B are diagrams for describing the operation guide information database SD4 in the management server device 1.

The operation guide information database SD4 stores and manages, for the purpose of providing services of informing general member users of venues for mobile sales, data about the member users and data about the mobile sales, and has a mail notification file SD4-1 depicted in FIG. 7A and an operation guide file SD4-2 depicted in FIG. 7B.

The mail notification file SD4-1 is a file for use in informing and notifying the member users of the data about the mobile sales via electronic mail, and has items of “member number”, “name”, “mail address”, “address”, “latitude”, and “longitude” as data about the users registered by inputting items in a membership registration application and items of “ramen shop”, . . . “oden shop” indicating genres desired to be informed. “Latitude” and “longitude” indicate position data of “address” of each member which have been received and obtained from the cartographic information server device 4.

The operation guide file SD4-2 is a file for use in guiding the user to a Web (World Wide Web) page for mobile sales provided by a site operator operating a site for mobile sales using a parking lot. As depicted in FIG. 7B, the operation guide file SD4-2 has items of “operating day”, “operation, “opening time”, and “closing time” as data regarding operation of mobile sales, items of “sales vehicle code”, “seller name”, “genre”, and “registration number” as data regarding sales vehicles, and items of “parking lot code”, “parking lot name”, “longitude”, and “latitude” as data regarding parking lots.

“Operation” is data indicating whether the shop is open or closed. Since the contents of the operation guide file SD4-2 are made public on a Web page, they can be freely viewed by anyone accessing the Web page.

In this case, for example, a URL (Uniform Resource Locator) to the Web page may be printed on a sales receipt issued by an ECR of a shop having a cooperative relationship with the mobile sales site, and the URL may be imaged by a camera-equipped portable terminal device owned by a general user so as to allow an access to the Web page.

Next, the operation concept of the sales data processing system in the present embodiment is described with reference to flowcharts depicted in FIG. 8 to FIG. 12.

Here, each function described in the flowcharts is stored in a readable program code format, and operations based on these program codes are sequentially performed.

Also, operations based on the above-described program codes transmitted over a transmission medium such as a network can also be sequentially performed. That is, the unique operations of the present embodiment can be performed using programs and data supplied from an outside source over a transmission medium, in addition to a recording medium.

FIG. 8 is a flowchart outlining the operation of a characteristic portion of the present embodiment from among all of the operations of the sales terminal device 2 installed in the mobile sales vehicle, which is started when power is turned ON.

FIG. 9 to FIG. 11 are flowcharts outlining the operation of a characteristic portion of the present embodiment from among all of the operations of the management server device 1, which is started when power is turned ON, and performed between the management server device 1 and the sales terminal device 2 of the mobile seller and between the management server device 1 and the terminal device 5 of the parking lot operator.

First, the CPU 21 of the sales terminal device 2 judges whether an operation for making a request for mobile sales using a parking lot has been performed by a user operation (Step A1 of FIG. 8). If another operation has been performed (NO at Step A1), the CPU 21 performs processing according to this operation, such as data setting processing or sales registration processing at the time of mobile sales at a venue other than a parking lot (Step A2), and then returns to Step A1.

When judged that an operation for making a request for mobile sales using a parking lot has been performed by the sales terminal device 2 (YES at Step A1), the CPU 21 receives and obtains current position data from the GPS positioning section 25 (Step A3), and then accesses the management server device 1 to make a request for the provision of an available parking lot nearby (Step A4).

In this case, the CPU 21 of the sales terminal device 2 reads out its own sales vehicle code and seller name, transmits a request for provision including the sales vehicle code, the seller name, and the current position data to the management server device 1, and enters a wait state for receiving parking lot data that is provided from the management server device 1 in response to the request for provision.

On the management server device 1 side, when the request for the provision of a parking lot is received from the sales terminal device 2 (YES at Step B1 of FIG. 9), the CPU 11 receives the sales vehicle code, the seller name, and the position data (Step B2), searches the parking lot information database SD1 for the parking lot file SD1-1 based on the position data, and reads out data regarding a parking lot near the sales terminal device 2 (Step B3).

In this case, the CPU 11 performs processing for searching for a parking lot located in a predetermined area (for example, an area within a radius of 3 km) from the received position data (the current position of the mobile sales vehicle), reading “parking lot code”, “parking lot name”, “unit fee per hour”, and “compensation rate for sales”, and transmitting the read items to the requesting sales terminal device 2 (Step B4). Then, the CPU 11 returns to Step B1.

Upon receiving the parking lot data from the management server device 1, the CPU 21 of the sales terminal device 2 judges whether an available nearby parking lot is present based on the reception result (Step A5 of FIG. 8). If no available nearby parking lot is present (NO at Step A5), the CPU 21 returns to Step A1. If an available nearby parking lot is present (YES at Step A5), the CPU 21 displays the received parking lot data on the touch input display section 23 for guiding (Step A6).

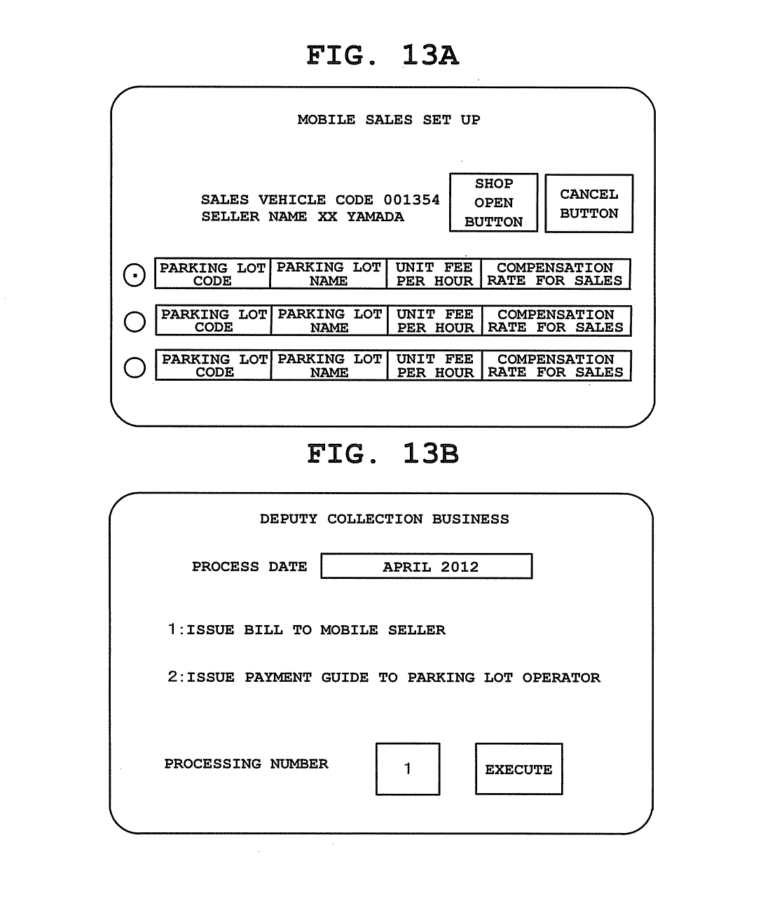

FIG. 13A depicts a parking lot data guide screen. The guide screen has a header area where “Open for mobile sales”, “sales vehicle code”, and “seller name” are displayed. The guide screen also has a detailed area where “parking lot code”, “parking lot name”, “unit fee per hour”, and “compensation for sales” for each parking lot are displayed as a list. Also, in the header area of the guide screen, a “shop open button” and a “cancel button” are arranged.

The “shop open button” is a button for, when a desired parking lot is present in the guide screen, starting mobile sales at the desired parking lot. The “cancel button” is a button operated when a desired parking lot is not present.

Next, the CPU 21 of the sales terminal device 2 judges whether the “shop open button” has been operated (Step A7) and judges whether the cancel button has been operated (Step A8).

When judged that the cancel button has been operated (YES at Step A8), the CPU 21 returns to Step A1. When judged that the shop open button has been operated (YES at Step A7), the CPU 21 accepts a parking lot selection operation for selecting a desired parking lot in the parking lot data guide screen (Step A9).

With this, when a desired parking lot is selected, the CPU 21 stores and retains the selected parking lot data (“parking lot code”, “parking lot name”, “unit fee per hour”, and “compensation for sales”) (Step A10), and notifies the management server device 1 of shop opening (Step A11).

In this case, the CPU 21 transmits to the management server device 1 a notification of shop opening including its own “sales vehicle code” and the “parking lot code” of the selected parking lot.

Then, after displaying a sales registration screen on the touch input display section 23 (Step A12), the CPU 21 judges whether a sales registration operation has been performed (Step A13), judges whether a shop close button (omitted in the drawings) has been operated, and enters an operation wait state (Step A18).

When judged that a registration operation for inputting sales data has been performed (YES at Step A13), the CPU 21 displays the inputted sales data on the sales registration screen (Step A14). Also, the CPU 21 receives and obtains from the GPS positioning section 25 current position data (the position of the parking area for mobile sales, that is, sales position) (Step A15).

Subsequently, the CPU 21 performs processing for registering the sales data and the position data in association with each other in a sales file (omitted in the drawings) of the sales management information database TD (Step A16).

Then, the CPU 21 transmits the sales data at the time of ending the registration for one transaction to the printer device 7 for printing and issuing a receipt (Step A17). Thereafter, the CPU 21 repeats the operations described above every time a sales registration operation is performed (Steps A13 to A17).

When the shop close button is operated (YES at Step A18), the CPU 21 performs processing for reading sales data and position data from the shop opening time to the shop closing time as contents of a sales report from the sales file, and transmitting a shop closing notification including its own sales vehicle code and parking lot code in use to the management server device 1 (Step A19).

Then, as operation cutoff processing, the CPU 21 performs, for example, processing for transmitting the contents of the sales file to the printer device 7 for printing and issuing a journal and making an addition to the sales total (Step A20).

Thereafter, the CPU 21 returns to Step A1.

On the other hand, when a shop opening notification from the sales terminal device 2 is received (YES at Step B5 of FIG. 9), the CPU 11 of the management server device 1 searches the sales vehicle file SD2-1 of the sales management information database SD2 based on the sales vehicle code included in the shop opening notification so as to read and obtain “seller name”, “genre”, and “registration number” (Step B6), and then searches the parking lot file SD1-1 of the parking lot information database SD1 based on the parking lot code included in the shop opening notification so as to read and obtain its “parking lot name”, “latitude”, and “longitude” (Step B7).

Then, the CPU 11 generates a sales guide record together with “sales vehicle code”, “seller name”, “genre”, “registration number”, “parking lot code”, “parking lot name”, “latitude”, and “longitude”, with the current date and time as an operating day and a shop opening time, and additionally registers the generated record in the operation guide file SD4-2 in the information database SD4 (Step B8).

Then, the CPU 11 sends to a relevant member user a mail notification of the operation guide so as to inform that a new shop has been opened (Step B9).

That is, the CPU 11 of the management server device 1 compares each record in the mail notification file SD4-1 with a record additionally registered in the operation guide file SD4-2. Then, if the user's address is near the parking lot for mobile sales and the mobile sales is of a genre desired by the user, a mail notification stating that a new shop has been opened is sent to the user. Thereafter, the CPU 11 returns to Step B1.

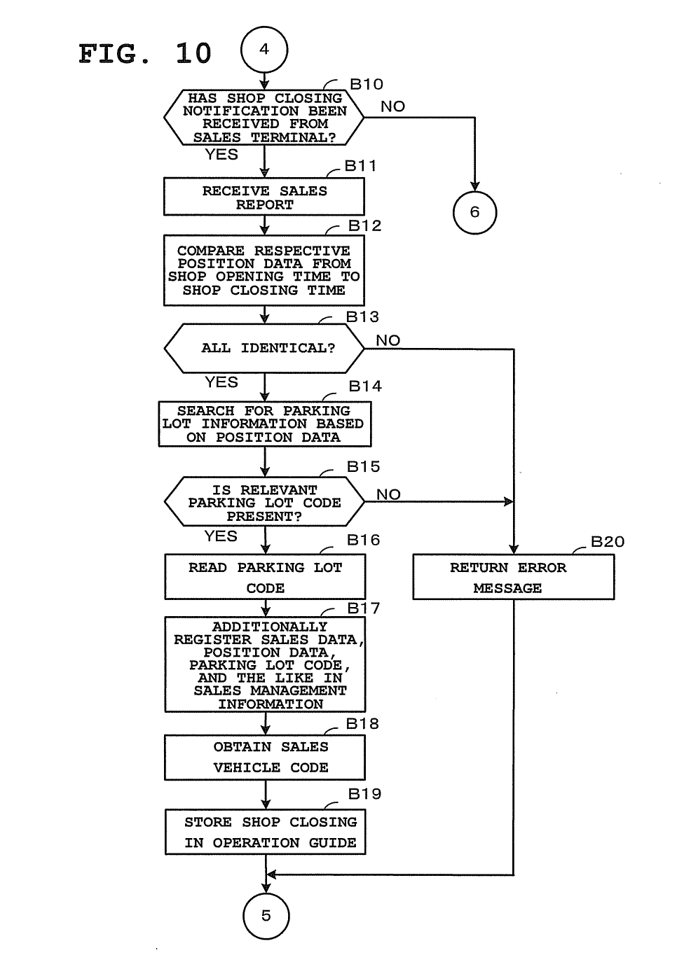

When a shop closing notification is received from the sales terminal device 2 (YES at Step B10 of FIG. 10), the CPU 11 of the management server device 1 receives and obtains a sales report (sales data and position data from the shop opening time to the shop closing time) included in the shop closing notification (Step B11).

Then, the CPU 11 compares the respective position data from the shop opening time to the shop closing time (Step B12) to judge whether these data are the same position data (Step B13).

If they are not the same position data (NO at Step B13), the CPU 11 creates an error message indicating this and transmits the error message to the sales terminal device 2 (Step B20).

Note that, when an error message is received from the management server device 1, the CPU 21 of the sales terminal device 2 displays the error message so that the mobile seller pursues the cause of the error and retransmits a sales report.

If the position data is the same from the shop opening time to the shop closing time (YES at Step B13), the CPU 11 searches the parking lot file SD1-1 of the parking lot information database SD1 based on the position data (Step B14) to judge whether the relevant “parking lot code” has been stored (Step B15).

When judged that the relevant “parking lot code” has not been stored (NO at Step B15), the CPU 11 creates an error message indicating this and transmits it to the sales terminal device 2 (Step 1320). When the relevant “parking lot code” has been stored, or in other words, when the parking lot can be specified (YES at Step B15), the CPU 11 reads out its “parking lot code” from the parking lot file SD1-1 (Step B16).

Next, the CPU 11 of the management server device 1 additionally registers data of necessary items such as the sales report (sales data and position data from the shop opening time to the shop closing time) and the parking lot code to the sales file SD3-1 of the sales management information database SD3 (Step 1317).

Then, the CPU 11 obtains the sales vehicle code from the shop closing notification (Step B18), searches the operation guide file SD4-2 based on the parking lot code and the sales vehicle code, changes “operation” in the relevant record from “open” to “closed”, and writes “shop closing time” thereon (Step B19).

Then, the CPU 11 returns to Step B1 of FIG. 9.

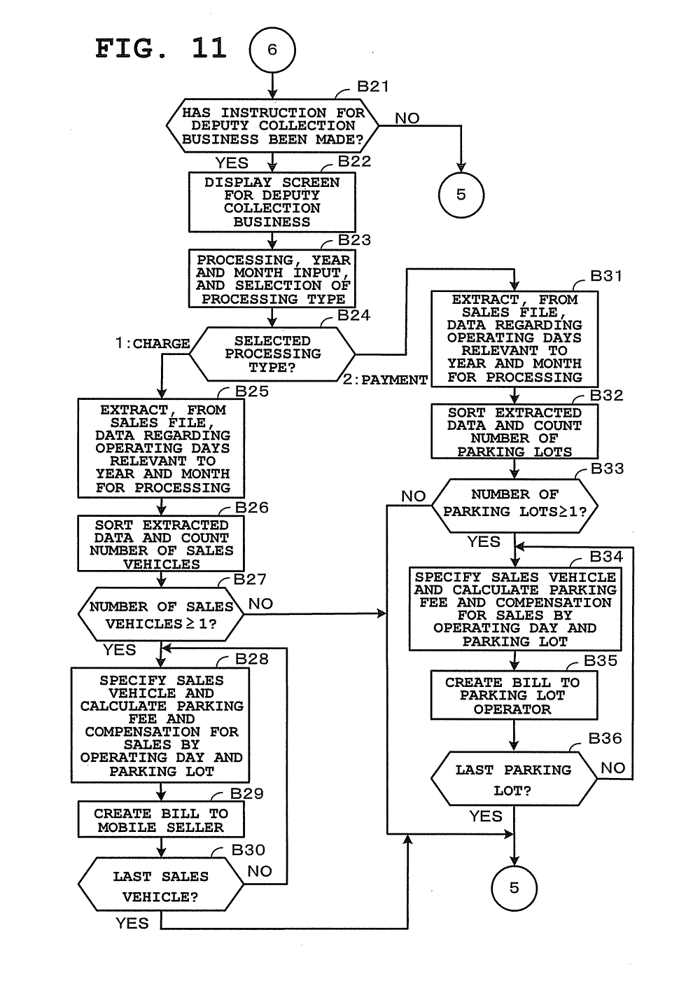

When it is detected that an operation to make an instruction for deputy collection business has been performed (YES at Step 1321 of FIG. 11), the CPU 11 of the management server device 1 displays a deputy collection business screen (Step B22).

FIG. 13B depicts the deputy collection business screen. On this deputy collection business screen, an area for inputting processing year and month is displayed. Also, as processing types, “1: ISSUE BILL TO MOBILE SELLER” and “2: ISSUE PAYMENT GUIDE TO PARKING LOT OPERATOR” are displayed, and also an area for inputting one of their processing numbers is displayed. On this deputy collection business screen, an “EXECUTE” button is arranged.

Here, when desired year and month to be processed and a processing number are inputted in the deputy collection business screen, and the “EXECUTE” button is operated (Step B23), the CPU 11 of the management server device 1 determines the type of the selected processing (Step B24).

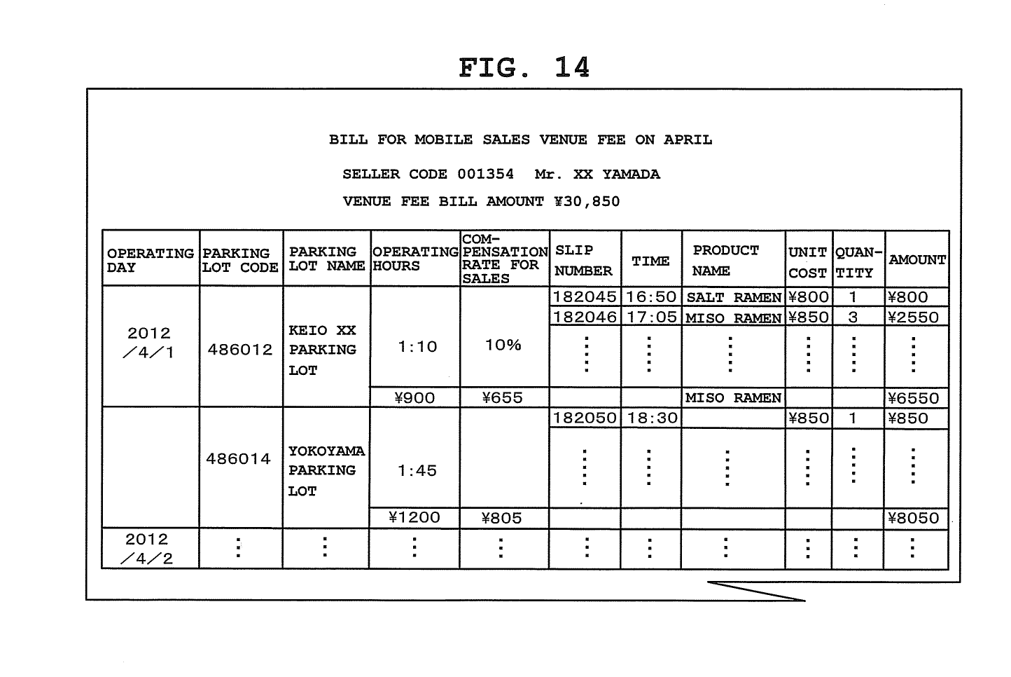

Here, when “1: ISSUE BILL TO MOBILE SELLER” is selected as the processing type (Step B24), the CPU 11 proceeds to bill issuance processing (Steps B25 to B30), and generates and issues a bill such as that depicted in FIG. 14.

First, the CPU 11 extracts sales data regarding operating days relevant to the year and month to be processed from the sales file SD3-1 (Step B25). Then, the CPU 11 sorts the extracted data in the order of “sales vehicle code”, “operating day”, “parking lot code”, and “slip number”, and counts the number of the sales vehicles (Step B26).

Then, the CPU 11 judges whether the counted number of the sales vehicles is equal to or larger than 1 (Step B27). When the number of the sales vehicles is not equal to or larger than 1 (NO at Step B27), a bill is not required to be issued, and therefore the CPU 11 returns to Step B1 of FIG. 9.

When the number of the sales vehicles is equal to or larger than 1 (YES at Step B27), the CPU 11 specifies the head sales vehicle from among the sales vehicles, and calculates a mobile sales use fee (a parking fee and a compensation for sales) based on each sales data by operating day and by parking lot used by the sales vehicle (Step B28).

That is, the CPU 11 finds “operating hours×time−unit fee of the parking lot×the number of parking spaces=parking fee serving as a venue fee” by operating day and by parking lot. The operating hours is hours from a shop opening time to a shop closing time, and a parking space is, for example, a space for one vehicle.

For example, when the operating hours is one hour and ten minutes, the time-unit fee is 200 yen for thirty minutes, and the number of parking spaces is one, the parking fee is 600 yen.

Also, the CPU 11 finds “sales total amount×compensation rate for sales at the parking lot=compensation for sales” by operating day and by parking lot. Here, the sales total amount is a value obtained by totalizing sales amount by operating day and by parking lot. For example, when the sales total amount is “6550 yen” and the compensation rate for sales is 10%, the compensation for sales is “655 yen”.

A value obtained by adding the parking fee and the compensation rate for sales together is the use fee for mobile sales. Then, after creating a bill to the mobile seller as depicted in FIG. 14 (Step B29), the CPU 11 judges whether bills have been created up to the last one of the extracted sales vehicles (Step B30). Hereafter, until the last sales vehicle is specified, the CPU 11 repeatedly returns to Step B28 to perform the above-described operation. When the last sales vehicle is specified (YES at Step B30), the CPU 11 returns to Step B1 of FIG. 9.

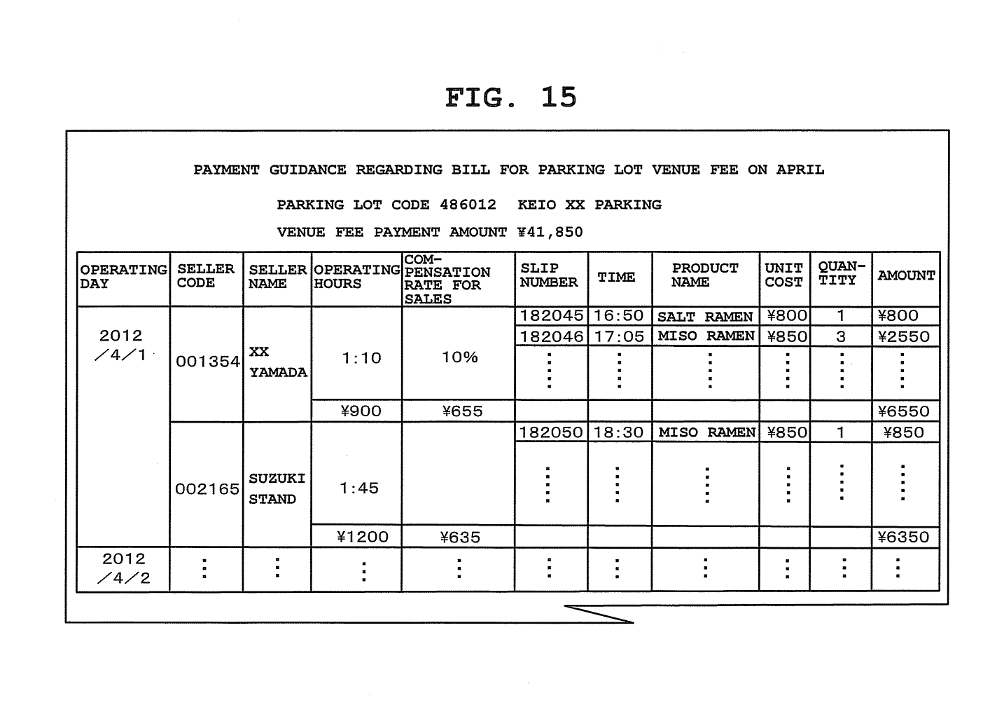

At Step B24, when “2: ISSUE PAYMENT GUIDE TO PARKING LOT OPERATOR” is selected as the processing type, the CPU 11 proceeds to payment guide issuance processing (Steps B31 to 1336), and generates and issues a payment guide such as that depicted in FIG. 15. This payment guide issuance processing (Steps B31 to B36) is basically similar to the bill issuance processing (Steps B25 to B30) described above.

First, the CPU 11 extracts sales data regarding operating days relevant to the year and month to be processed from the sales file SD3-1 (Step 1331). Then, the CPU 11 sorts the extracted data in the order of “parking lot code”, “operating day”, “sales vehicle code”, and “slip number”, and counts the number of the parking lots (Step B32).

Then, the CPU 11 judges whether the counted number of the parking lots is equal to or larger than 1 (Step 1333). When the number of the parking lots is not equal to or larger than 1 (NO at Step B33), a payment guide is not required to be issued, and therefore the CPU 11 returns to Step B1 of FIG. 9.

When the number of the parking lots is equal to or larger than 1 (YES at Step B33), the CPU 11 specifies the head parking lot from among the parking lots, calculates a mobile sales use fee (a parking fee and a compensation for sales) based on each sales data by operating day and by sales vehicle using the parking lot (Step B34), and thereby creates a payment guide to the parking lot operator as depicted in FIG. 15 (Step S35).

Then, the CPU 11 judges whether payment guides have been created up to the last one of the extracted parking lots (Step B36). Hereafter, until the last parking lot is specified, the CPU 11 repeatedly returns to Step B34 to perform the above-described operation. When the last parking lot is specified (YES at Step B36), the CPU 11 returns to Step B1 of FIG. 9.

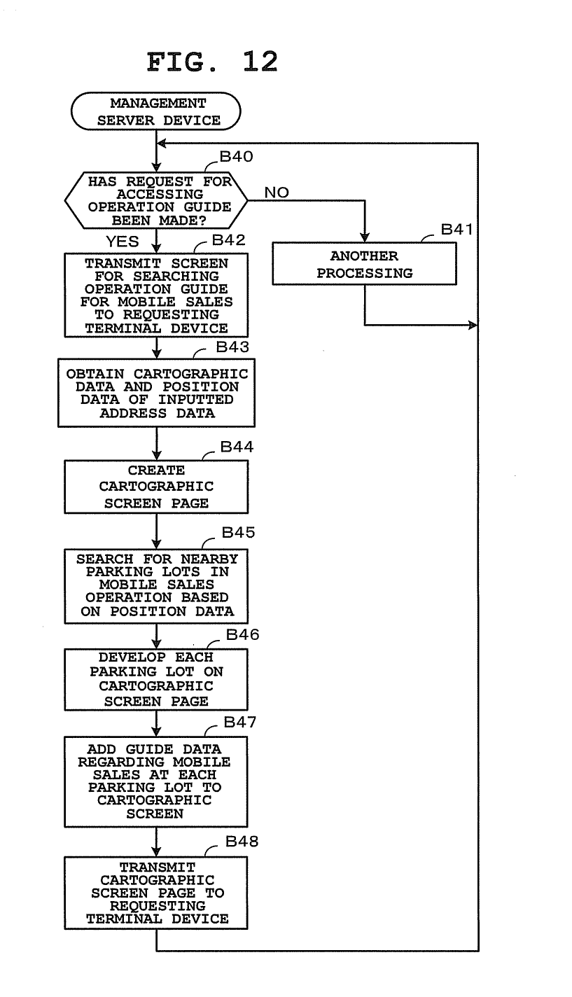

FIG. 12 is a flowchart of an operation that is started in the management server device 1 when the Web page for mobile sales guiding is accessed from the terminal device 6 on the general user side. Here, the Web page for mobile sales guiding is accessed not only by the terminal device 6 on the general user side but also a terminal device on a parking lot operator side or a terminal device on a mobile seller side so as to allow a current operation state to be checked.

First, the CPU 11 of the management server device 1 judges whether a request for accessing the Web page for mobile sales guide has been made (Step 1340 of FIG. 12). When judged that another Web page has been accessed (NO at Step 1340), the CPU 11 proceeds to another processing (Step B41). When judged that the Web page for mobile sales guiding has been accessed (YES at Step B40), the CPU 11 transmits a mobile sales operation guide search screen to the requesting terminal device (Step 1342).

The mobile sales operation guide search screen is provided with an input item by which an area desired to be searched for is specified with an address. When address data inputted in that search screen is received, the CPU 11 receives and obtains cartographic data and position data of the address data from the cartographic information server device 4 (Step B43), and creates a cartographic screen based on the cartographic data (Step B44).

Then, the CPU 11 searches the operation guide file SD4-2 based on the position data, specifies nearby parking lots where mobile sales are being conducted (Step B45), and develops each parking lot in the cartographic screen (Step B46).

Then, after adding guide data regarding mobile sales at each parking lot to the cartographic screen (Step B47), the CPU 11 transmits the cartographic screen page to the requesting terminal device (Step B48). Thereafter, the operations described above are repeated every time the Web page for mobile sales guiding is accessed.

As described above, when current position data and sales data are received from the sales terminal device 2 installed in the mobile sales vehicle as a sales report of mobile sales, the CPU 11 of the management server device 1 constituting the sales data processing system of the present embodiment searches the parking lot information database SD1 based on the position data so as to specify a parking area relevant to the position data, and processes the received sales data as sales data for sales in the parking area. As a result of this configuration, a sales venue can be easily provided to a mobile sales vehicle, whether mobile sales are being conducted at an appropriate venue can be easily confirmed, whereby mobile sales can be promoted and parking lots can be effectively used.

That is, only by participating in the site for mobile sales using parking lots, mobile sellers can freely secure a registered parking area as a mobile sales venue anytime. Also, as a result of the number of sales venues being increased, the mobile sellers can freely change their sales venues in accordance with the customer attraction state and the like. Thus, a significant increase in sales can be expected.

Moreover, the parking lot operators can effectively use a free space at nighttime, on holidays, and the like without changing the conventional parking system. As a result, a significant increase in parking lot profit can be expected.

As such, since there are large advantages for both of the mobile seller and the parking lot operator, promotion of participation in the mobile sales site can also be expected.

Also, when current position data and sales data are received as a sales report of mobile sales from the sales terminal device 2, the CPU 11 of the management server device 1 specifies a parking area relevant to the position data, and stores the received sales data in the sales file SD3-1, in association with the parking area. As a result of this configuration, sales venues can be confirmed for each sales data, and reliability as a whole system can be increased.

Moreover, based on a parking area and sales data stored in the sales file SD3-1, the CPU 11 of the management server device 1 calculates a compensation for sales according to the sales data. In addition, the CPU 11 finds a mobile sales use fee by calculating a parking fee according to the time of using the parking area. Therefore, the parking lot operator can obtain a new profit, which is a compensation for sales, in accordance with the sales data, in addition to the parking fee according to the time of using the parking area.

Furthermore, the CPU 11 of the management server device 1 creates a payment report for reporting a mobile sales use fee for a parking lot to the parking lot operator. Therefore, a deputy collection business can be smoothly performed.

Still further, the CPU 11 of the management server device 1 creates a bill requesting a mobile seller to pay a mobile sales use fee for a parking lot. Therefore, a deputy collection business can be further smoothly performed.

Yet still further, when a request for provision of a parking lot for use in mobile sales is received from the terminal device (such as the sales terminal device 2, a portable terminal device, or a personal computer) of a mobile seller, the CPU 11 of the management server device 1 searches the parking lot information database SD1 based on current position data received together with the request so as to specify a parking area which is near the position from which the request has been sent and available for use in mobile sales, and transmits data regarding the use of the parking area to the requesting device. As a result of this configuration, parking area where the use of mobile sales is allowed can be instantaneously found and a shop can be opened there anytime.

Yet still further, since the CPU 11 of the management server device 1 specifies a plurality of adjacent parking spaces (for example, spaces for two vehicles) in a parking lot, a space suitable for use in mobile sales can be ensured.

Yet still further, the CPU 11 of the management server device 1 transmits, to pre-registered users, data regarding the location of a parking area that is used for mobile sales and data regarding products that are sold at the parking area, via a notification e-mail. Therefore, a guide can be provided only to prospective customers, which is effective in sales promotion.

Yet still further, the CPU 11 of the management server device 1 publishes, on the Web page for mobile sales guiding, data regarding the location of a parking area that is used for mobile sales and data regarding products that are sold at the parking area. Therefore, a guide can be provided only to prospective customers, which is also effective in sales promotion.

In the above-described embodiment, the processing depicted in FIG. 9 to FIG. 11 and the processing depicted in FIG. 12 are performed by the same management server device 1. However, the processing depicted in FIG. 9 to FIG. 11 and the processing depicted in FIG. 12 may be individually performed by a plurality of management server devices 1.

Also, in the above-described embodiment, when a request for provision of a parking lot for use in mobile sales is received from the terminal device (such as the sales terminal device 2, a portable terminal device, or a personal computer) of a mobile seller, the CPU 11 of the management server device 1 searches the parking lot information database SD1 based on current position data received together with the request so as to specify a parking area which is near the position from which the request has been sent and available for use in mobile sales, and transmits data regarding the use of the parking area to the requesting device. However, in addition to this, the CPU 11 may transmit the current use state (a vacancy state), in conjunction with the parking system.

Moreover, although the parking area in the above-described embodiment is a parking lot, it may be a parking space for one vehicle. In this case, position data is received and obtained for each parking space even when they are within the same parking lot.

Furthermore, in the above-described embodiment, sales data and position data for one transaction are associated with each other. However, image data obtained by imaging a sales scene by an imaging device may be additionally associated.

Still further, in the above-described embodiment, a configuration may be adopted in which, when a payment report for reporting a mobile sales use fee for a parking lot to the parking lot operator is created, the management server device 1 prints the payment report and transmits it to the terminal device 5 of the parking lot operator.

Similarly, a configuration may be adopted in which, when a bill for requesting a mobile seller to pay a mobile sales use fee for a parking lot is created, the management server device 1 prints the bill and transmits it to the terminal device of the mobile seller.

Yet still further, the “devices” or the “sections” described in the above-described embodiment are not required to be in a single housing and may be separated into a plurality of housings by function.

In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. A data processing apparatus which receives sales data transmitted from a terminal device installed in a mobile sales vehicle via a communication network and processes the sales data, comprising:
a receiving section which receives current position data together with sales data from the terminal device, as a sales report of mobile sales;
a sales venue storage section which stores and manages position data for each of sales venues where mobile sales by mobile sales vehicles are permitted under contracts with operators operating business of renting the sales venues by hour;
a search section which specifies a sales venue relevant to the position data by searching the sales venue storage section based on the position data received together with the sales data by the receiving section; and
a processing section which processes, when the sales venue is specified by the search section, the sales data received by the receiving section as sales data regarding sales at the sales venue.

2. The data processing apparatus according to claim 1, further comprising:
a sales data storage section which stores and manages the sales data regarding the sales at the sales venue,
wherein the processing section stores the sales data received by the receiving section in the sales data storage section, in association with the sales venue specified by the search section.

3. The data processing apparatus according to claim 2, further comprising:
a calculation section which calculates a compensation for sales according to the sales data based on the sales venue and the sales data stored in the sales data storage section, and finds a mobile sales use fee by calculating a use fee according to a time of using the sales venue.

4. The data processing apparatus according to claim 3, further comprising:
a payment report creating section which creates a payment report for reporting the use fee calculated by the calculation section to the operator.

5. The data processing apparatus according to claim 3, further comprising:
a bill creating section which creates a bill for requesting a mobile seller to pay the use fee calculated by the calculation section.

6. The data processing apparatus according to claim 1, wherein the search section searches, when a request for provision of a sales venue for use in mobile sales is received from the terminal device, the sales venue storage section based on current position data received together with the request so as to specify a sales venue which is near a position from which the request has been sent and available for use in mobile sales, and
wherein the data processing apparatus further comprises a transmission section which transmits data regarding use of the sales venue specified by the search section to the terminal device that has made the request.

7. The data processing apparatus according to claim 1, wherein the search section specifies a plurality of sales venues adjacent to each other in the sales venue.

8. The data processing apparatus according to claim 1, further comprising:
a guide section which transmits venue-related data of the sales venue that is used for the mobile sales and data regarding a product that is sold at the sales venue to a pre-registered user via the communication network.

9. The data processing apparatus according to claim 1, further comprising:
a publication section which publishes venue-related data of the sales venue that is used for the mobile sales and data regarding a product that is sold at the sales venue such that the venue-related data and the data regarding the product are viewable via the communication network.

10. A non-transitory computer-readable storage medium having stored thereon a program that is executable by a computer, the program being executable by the computer to perform functions comprising:
processing for receiving current position data together with sales data from a terminal device installed in a mobile sales vehicle, as a sales report of mobile sales;
processing for storing and managing position data for each of sales venues where mobile sales by mobile sales vehicles are permitted under contracts with operators operating business of renting the sales venues by hour;
processing for specifying a relevant sales venue based on the position data received together with the sales data from the terminal device; and
processing for, when the sales venue is specified, causing the received sales data to be processed as sales data regarding sales at the sales venue.
